(19) United States
(12) Patent Application Publication
(10) Pub. No.: US 2010/0128462 A1
(43) Pub. Date: May 27, 2010

(54) ILLUMINATION DEVICE WITH SELECTABLE OPTICAL WAVELENGTH CONVERSION

(75) Inventors: JYH-LONG CHERN, Chu-Nan (TW); CHIH-MING LAI, Chu-Nan (TW)

Correspondence Address: PCE INDUSTRY, INC.;ATT. Steven Reiss, 288 SOUTH MAYO AVENUE, CITY OF INDUSTRY, CA, 91789, US

(73) Assignee: FOXSEMICON INTEGRATED TECHNOLOGY, INC., Chu-Nan (TW)

(21) Appl. No.: 12/541,360

(22) Filed: Aug. 14, 2009

(30) Foreign Application Priority Data
Nov. 25, 2008 (CN) 200810305713.3

(51) Int. Cl. F21V 9/16; F21S 6/00

(52) U.S. Cl. 362/84; 362/257

(57) ABSTRACT

An illumination device includes a light source emitting light of certain wavelength and a light transmissive element having optical wavelength converting regions. Each optical wavelength converting region can be selectively positioned opposite to the light source. The optical wavelength converting region opposite to the light source receive the light emitted from the light source and convert the wavelength of the light.

### BACKGROUND

1. Technical Field

The present disclosure generally relates to illumination devices, and particularly to an illumination device configured (i.e., structured and arranged) to be able to output light of different wavelengths according to need.

2. Description of Related Art

LEDs have recently been used extensively as light sources for illumination devices due to their high luminous efficiency, low power consumption and long working life. In some LED illumination devices, to satisfy certain illumination requirements, light mixing is employed. That is, light having different colors or wavelengths is emitted from different light emitting diodes, and such light is mixed to form light of a desired color or wavelength. However, once the different light emitting diodes of the illumination device are encapsulated together to emit light of a desired color or wavelength, further change in the color or wavelength of the light is not possible.

Therefore, what is needed is an illumination device that overcomes the described limitations.

### BRIEF DESCRIPTION OF THE DRAWINGS

Many aspects of the disclosed illumination device can be better understood with reference to the following drawings. The components in the drawings are not necessarily drawn to scale, the emphasis instead being placed upon clearly illustrating the principles of the present illumination device.

FIG. 1 is a schematic view of an illumination device of a first embodiment.

FIG. 2 is a schematic view of a variation of the first embodiment of the illumination device.

FIG. 3 is a schematic view of an illumination device of a second embodiment.

FIG. 4 is a schematic view of a variation of the second embodiment of the illumination device.

FIG. 5 is a schematic view of an illumination device of a third embodiment.

### DETAILED DESCRIPTION

Reference will now be made to the drawings to describe various embodiments of the illumination device, in detail.

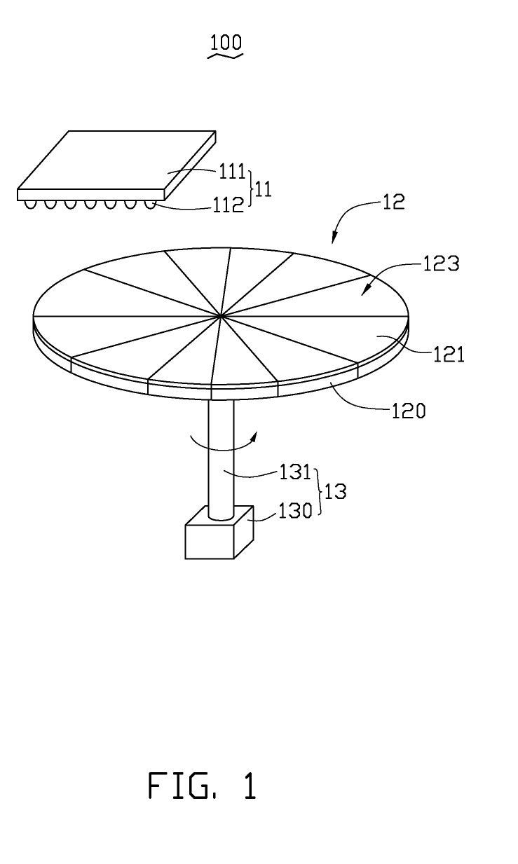

Referring to FIG. 1, an illumination device 100 of a first embodiment includes a light source 11, a light transmissive element 12, and a driving module 13.

The light source 11 includes a substrate 111, and a plurality of light emitting diodes 112 arranged on the substrate 111. The light source 11 can be used for emitting monochromatic light or ultraviolet light. In an exemplary embodiment, the light source 11 emits ultraviolet light, and a full width at half maximum of the ultraviolet light is no more than 30 nanometers (nm).

The light transmissive element 12 is arranged at a light emitting side of the light source 11. The light transmissive element 12 has a light transmittance of at least 70%. Thus, optical loss of the light emitted from the light source 11 in the light transmissive element 12 may be considered to be acceptable.

The light transmissive element 12 is generally round. The light transmissive element 12 includes a light transmissive substrate 120, and an optical wavelength converting substance 121 formed on the substrate 120, here, as a film. The substrate 120 can be resin, silicone, glass, polyethylene terephthalate, polymethyl methacrylate or polycarbonate. The optical wavelength converting substance 121 can be made of a phosphor substance comprising sulfides, aluminates, oxides, silicates, or nitrides. For example, the optical wavelength converting substance 121 can be made of Ca₂Al₁₂O₁₉:Mn, (Ca,Sr,Ba)Al₂O₄:Eu, CdS, CdTe, Y₃A₁₅O12Ce³⁺(YAG), Tb₃Al₅O₁₂:Ce³⁺(YAG), BaMgAl₁₀O₁₇:Eu²⁺(Mn²⁺, (Ca,Sr,Ba)S:Eu²⁺, (Mg,Ca,Sr,Ba)₂SiO₄:Eu²⁺, (Mg,Ca,Sr,Ba)₃Si₂O₇:Eu²⁺, Y₂O₂S:Eu³⁺, Ca₈Mg(SiO₄)₄Cl₂:Eu²⁺, (Sr,Ca,Ba)SiₓO_{y}N_{z:Eu}²⁺, (Ca,Mg,Y)SiwAlₓO_{y}N_{z}:Eu²⁺, or CdSe.

The light transmissive element 12 is divided into a plurality of optical wavelength converting regions 123. Each of the optical wavelength converting regions 123 is sector-shaped, and the optical wavelength converting regions 123 are arranged side by side around a center of the light transmissive element 12. Each optical wavelength converting region 123 includes a sector-shaped part of the substrate 120, and a sector-shaped part of the optical wavelength converting substance 121 thereon. Here, each optical wavelength converting region 123 has a uniform concentration of optical wavelength converting material in the sector-shaped part of the optical wavelength converting substance 121. The concentration of each optical wavelength converting region 123 is different from that of all of the other optical wavelength converting regions 123. Therefore, light passing through the different optical wavelength converting regions 123 is absorbed in varying degrees, and the mixed light output from the different optical wavelength converting regions 123 has different colors or/and chromas.

In alternative embodiments, the optical wavelength converting substance 121 of each optical wavelength converting region 123 is a different substance from the optical wavelength converting substance 121 of all of the other optical wavelength converting regions 123.

Alternatively, the optical wavelength converting substance 121 can be omitted. Instead, optical wavelength converting material is mixed in a base material of the substrate 120. In such case, each of the optical wavelength converting regions 123 has a concentration of optical wavelength converting material different from that of all of the other optical wavelength converting regions 123.

The driving module 13 includes a motor 130 driving a rotatable shaft 131. The rotatable shaft 131 has one end portion fixed to the center of the light transmissive element 12, which is, accordingly, rotated thereby. Any one of the optical wavelength converting regions 123 can be selectively positioned opposite to the light source 11, to receive light emitted from the light source 11 and convert the wavelength of the light to a desired wavelength. In certain embodiments, two or more optical wavelength converting regions 123 can be selectively simultaneously positioned opposite to the light source 11.

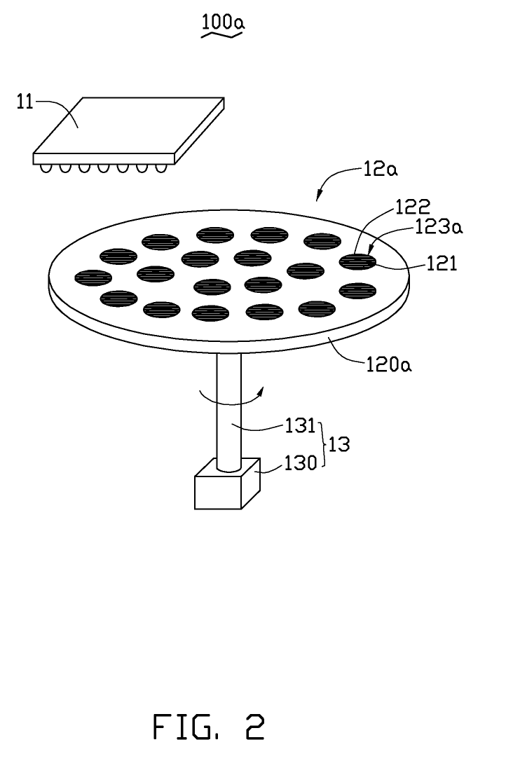

FIG. 2 is a schematic view of an illumination device 100a, which is a variation of the first embodiment. The illumination device 100a includes a light source 11, a light transmissive element 12a, and a driving module 13. The light transmissive element 12a includes a light transmissive substrate 120a. The substrate 120a has a plurality of receiving holes 122 formed therein. Each of the receiving holes 122 has an optical wavelength converting substance 121 received therein. In the illustrated embodiment, each receiving hole 122 is a blind hole. As such, each receiving hole 122 with the optical wavelength converting substance 121 received therein and a corresponding portion of the substrate 120a below the receiving hole 122 cooperatively form an optical wavelength converting region 123a.

The light transmissive element 12a can be rotated by the driving module 13. Any one of the optical wavelength converting regions 123a can be selectively positioned opposite to the light source 11, to receive light emitted from the light source 11 and convert the wavelength of the light to a desired wavelength. In certain embodiments, two or more optical wavelength converting regions 123a can be selectively simultaneously positioned opposite to the light source 11.

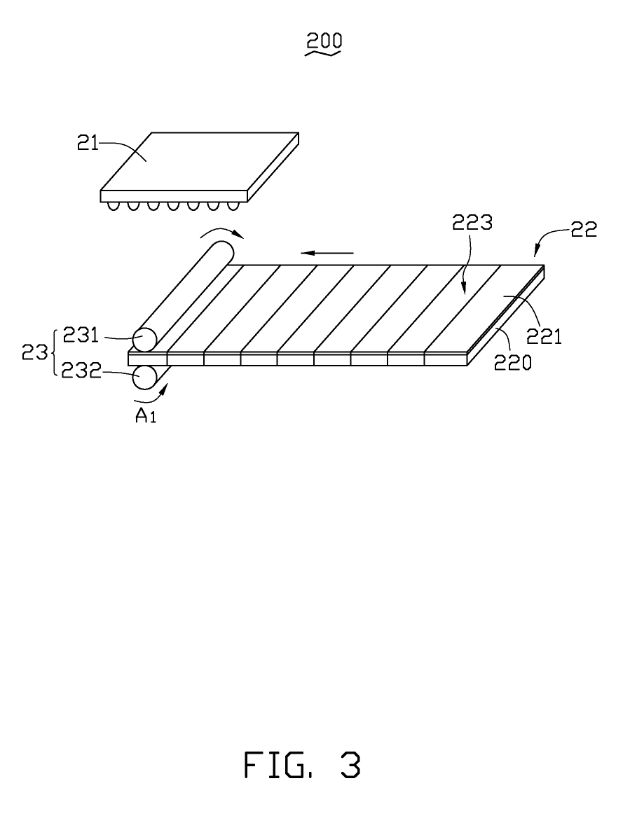

FIG. 3 is a schematic view of an illumination device 200 of a second embodiment. The illumination device 200 includes a light source 21, a light transmissive element 22, and a driving module 23.

The light source 21 is similar to the above-described light source 11.

The light transmissive element 22 is arranged at a light emitting side of the light source 21, and is rectangular. The light transmissive element 22 includes a light transmissive substrate 220, and an optical wavelength converting substance 221 formed on the substrate 220 (in this embodiment, in the form of a film). The substrate 220 can be similar to the substrate 120. The optical wavelength converting substance 221 can be similar to the optical wavelength converting substance 121.

The light transmissive element 22 is divided into a plurality of optical wavelength converting regions 223. Each of the optical wavelength converting regions 223 is rectangular. In the illustrated embodiment, each optical wavelength converting region 223 is strip-shaped. The optical wavelength converting regions 223 are arranged side by side. Each optical wavelength converting region 223 includes a rectangular (strip-shaped) part of the substrate 220, and a rectangular (strip-shaped) part of the optical wavelength converting substance 221 thereon. Each optical wavelength converting region 223 has a uniform concentration of optical wavelength converting material in the strip-shaped part of the optical wavelength converting substance 221. The concentration of each optical wavelength converting region 223 is different from that of all of the other optical wavelength converting regions 223. Therefore, light passing through the different optical wavelength converting regions 223 is absorbed in varying degrees, and the mixed light output from the different optical wavelength converting regions 223 has different colors or/and chromas.

In alternative embodiments, the optical wavelength converting substance 221 of each optical wavelength converting region 223 is a different substance from the optical wavelength converting substance 221 of all of the other optical wavelength converting regions 223.

Alternatively, the optical wavelength converting substance 221 can be omitted. Instead, optical wavelength converting material is mixed in a base material of the substrate 220. In such case, each of the optical wavelength converting regions 223 has a concentration of optical wavelength converting material different from that of all of the other optical wavelength converting regions 223.

The driving module 23 includes two opposite driving wheels 231, 232. The two driving wheels 231, 232 both contact the light transmissive element 22, such that the light transmissive element 22 can be moved along a common tangent direction of the driving wheels 231, 232. In the illustrated embodiment, the driving wheels 231, 232 are in the form of driving cylinders. Any one of the optical wavelength converting regions 223 can be selectively positioned opposite to the light source 21, to receive light emitted from the light source 21 and convert the wavelength of the light to a desired wavelength. In certain embodiments, two or more optical wavelength converting regions 223 can be selectively simultaneously positioned opposite to the light source 21.

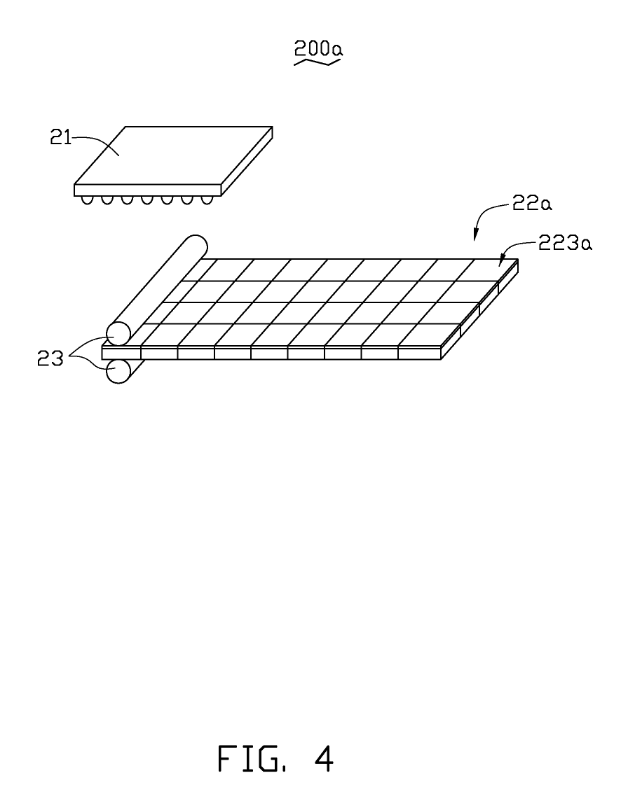

FIG. 4 is a schematic view of an illumination device 200a, which is a variation of the second embodiment. The illumination device 200a includes a light source 21, a light transmissive element 22a, and a driving module 23. The illumination device 200a has a configuration similar to the illumination device 200, differing in that the light transmissive element 22a is divided into a plurality of optical wavelength converting regions 223a which are arranged in an m×n matrix array. The light transmissive element 22a can be linearly driven by the driving module 23. In a typical embodiment, several of the optical wavelength converting regions 223a can be selectively simultaneously arranged opposite to the light source 21, to receive light emitted from the light source 21 and convert the wavelength of the light to a desired wavelength or wavelengths.

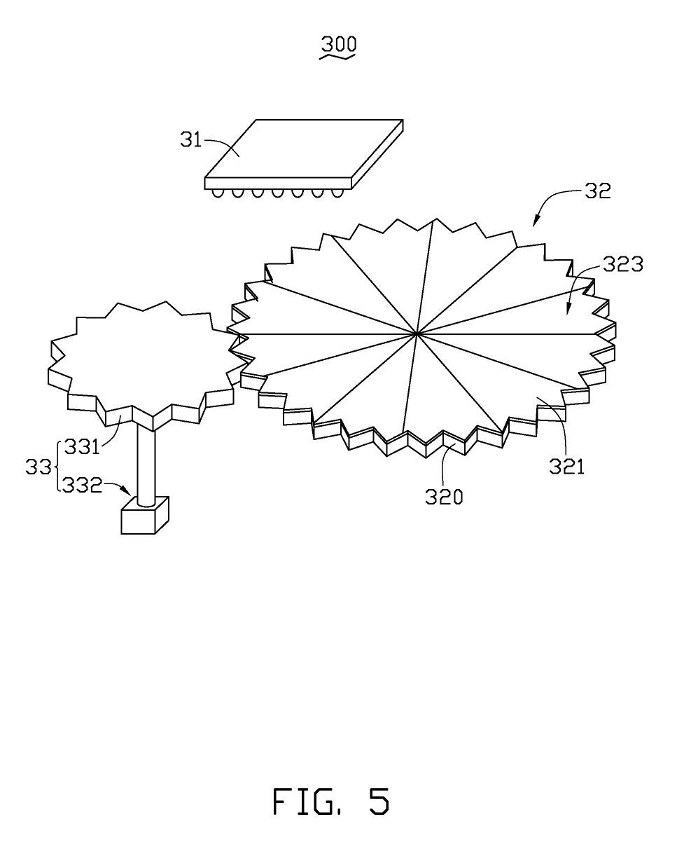

FIG. 5 is a schematic view of an illumination device 300 of a third embodiment. The illumination device 300 includes a light source 31, a light transmissive element 32, and a driving module 33.

The light source 31 is similar to the above-described light source 11.

The light transmissive element 32 is arranged at a light emitting side of the light source 31. The light transmissive element 32 is generally round, and includes a plurality of gear teeth (not labeled) on a periphery thereof. The light transmissive element 32 includes a light transmissive substrate 320, and an optical wavelength converting substance 321 formed on the substrate 320, here, as a film. The substrate 320 can be similar to the substrate 120. The optical wavelength converting substance 321 can be similar to the optical wavelength converting substance 121.

The light transmissive element 32 is divided into a plurality of optical wavelength converting regions 323. Each of the optical wavelength converting regions 323 is generally sector-shaped, and the optical wavelength converting regions 323 are arranged side by side around a center of the light transmissive element 32. Each optical wavelength converting region 323 includes a generally sector-shaped part of the substrate 320, and a generally sector-shaped part of the optical wavelength converting substance 321 thereon. Each optical wavelength converting region 323 has a uniform concentration of optical wavelength converting material in the generally sector-shaped part of the optical wavelength converting substance 321. The concentration of each optical wavelength converting region 323 is different from that of all of the other optical wavelength converting regions 323. Therefore, light passing through the different optical wavelength converting regions 323 is absorbed in varying degrees, and the mixed light output from the different optical wavelength converting regions 323 has different colors or/and chromas.

Alternatively, the optical wavelength converting substance 321 can be omitted. Instead, optical wavelength converting material is mixed in a base material of the substrate 320. In such case, each of the optical wavelength converting regions 323 has a concentration of optical wavelength converting material different from that of all of the other optical wavelength converting regions 323.

The driving module 33 includes a gear wheel 331 with a plurality of gear teeth, and a motor 332 for rotating the gear wheel 331. One or more of the gear teeth of the gear wheel 331 are meshed with one or more of the gear teeth of the light transmissive element 32. Thereby, the light transmissive element 32 is indirectly rotated by the motor 332. Any one of the optical wavelength converting regions 323 can be selectively positioned opposite to the light source 31, to receive light emitted from the light source 31 and convert the wavelength of the light to a desired wavelength. In certain embodiments, two or more optical wavelength converting regions 323 can be selectively simultaneously positioned opposite to the light source 31.

In summary, the illumination devices 100, 200, 300 are equipped with light transmissive elements 12, 22, 32 having a plurality of optical wavelength converting regions 123, 223, 323. One or more of the optical wavelength converting regions 123, 223, 323 can be selectively positioned opposite to the light sources 11, 21, 31, such that the color or/and chroma of the illumination devices 100, 200, 300 can be flexibly changed according to different requirements.

Finally, it is to be understood that the above-described embodiments are intended to illustrate rather than limit the disclosure. Variations may be made to the embodiments without departing from the spirit of the disclosure. The above-described embodiments illustrate the scope of the disclosure but do not restrict the scope of the disclosure.

What is claimed is:

1. An illumination device, comprising:
a light source; and
a light transmissive element comprising a plurality of optical wavelength converting regions;
wherein the light transmissive element is movable such that any of the optical wavelength converting regions can be selectively positioned opposite to the light source, and said any of the optical wavelength converting regions can thereby receive light emitted from the light source and convert the wavelength of the light.

2. The illumination device according to claim 1, wherein the light transmissive element comprises a light transmissive substrate, each of the optical wavelength converting regions comprising part of the substrate and an optical wavelength converting substance uniformly distributed at a location selected from the group consisting of on the part of the substrate and in the part of the substrate.

3. The illumination device according to claim 2, wherein the optical wavelength converting substance of the plurality of optical wavelength converting regions is the same substance, and each optical wavelength converting region comprises a concentration of the optical wavelength converting substance different from that of all of the others.

4. The illumination device according to claim 2, wherein the optical wavelength converting substance of each optical wavelength converting region is a different substance from the optical wavelength converting substance of all of the other optical wavelength converting regions.

5. The illumination device according to claim 2, wherein the substrate comprises material selected from the group consisting of resin, silicone, glass, polyethylene terephalate, polymethyl methacrylate, and polycarbonate.

6. The illumination device according to claim 2, wherein the optical wavelength converting substance comprises a phosphor substance comprising material selected from the group consisting of sulfides, aluminates, oxides, silicates, and nitrides.

7. The illumination device according to claim 1, wherein the light transmissive element comprises a light transmissive substrate with a plurality of receiving holes therein, and each of the receiving hole comprises an optical wavelength converting substance received therein, such that each receiving hole and the optical wavelength converting substance received therein cooperatively forms an optical wavelength converting region.

8. The illumination device according to claim 7, wherein the optical wavelength converting substance of the plurality of optical wavelength converting regions is the same substance, and each optical wavelength converting region comprises a concentration of the optical wavelength converting substance different from that of all of the others.

9. The illumination device according to claim 7, wherein the optical wavelength converting substance of each optical wavelength converting region is a different substance from the optical wavelength converting substance of all of the other optical wavelength converting regions.

10. The illumination device according to claim 7, wherein the light transmissive substrate comprises material selected from the group consisting of resin, silicone, glass, polyethylene terephthalate, polymethyl methacrylate, and polycarbonate.

11. The illumination device according to claim 7, wherein the optical wavelength converting substance comprises a phosphor substance comprising material selected from the group consisting of sulfides, aluminates, oxides, silicates, and nitrides.

12. The illumination device according to claim 1, wherein the light source is configured to emit monochromatic light.

13. The illumination device according to claim 1, wherein the light source is configured to emit ultraviolet light.

14. The illumination device according to claim 1, further comprising a driving module for moving at least one selected optical wavelength converting region to a position opposite the light source.

15. The illumination device according to claim 14, wherein the light transmissive element is round, each of the optical wavelength converting regions is sector-shaped, the plurality of optical wavelength converting regions is arranged side by side around a center of the light transmissive element, the driving module comprises a rotatable shaft and a motor for rotating the shaft, and one end portion of the shaft is fixed to the center of the light transmissive element.

16. The illumination device according to claim 14, wherein each of the optical wavelength converting regions is rectangular, and the plurality of optical wavelength converting regions are arranged side by side such that the light transmissive element is rectangular, and the driving module comprises at least one driving wheel for moving the light transmissive element along a tangent direction of the driving wheel.

17. The illumination device according to claim 14, wherein each of the optical wavelength converting regions is rectangular, and the plurality of optical wavelength converting regions are arranged in an m x n matrix array such that the light transmissive element is rectangular, and the driving module comprises at least one driving wheel for moving the light transmissive element along a tangent direction of the driving wheel.

18. The illumination device according to claim 14, wherein the light transmissive element is generally round and comprises a plurality of gear teeth on a periphery thereof, each of the optical wavelength converting regions is generally sector-shaped, the plurality of optical wavelength converting regions are arranged side by side around a center of the light transmissive element, the driving module comprises a gear wheel and a motor for rotating the gear wheel, the gear wheel comprises a plurality of gear teeth, and one of more of the gear teeth of the gear wheel are meshed with one of more of the gear teeth of the light transmissive element.
